(19) United States
(12) Patent Application Publication
(10) Pub. No.: US 2009/0210601 A1
(43) Pub. Date: Aug. 20, 2009

(54) SYSTEMS AND METHODS FOR PROVIDING A VIRTUAL NETWORK INTERFACE CONNECTION ("NIC") WITH THE BASEBOARD MANAGEMENT CONTROLLER ("BMC")

(75) Inventor: Eilon Greenstein, Kfar-Saba (IL)

Correspondence Address: Weiss & Arons, LLP, 1540 Route 202, Suite 8, Pomona, NY, 10970, US

(73) Assignee: Broadcom Corporation, Irvine, CA (US)

(21) Appl. No.: 12/033,978

(22) Filed: Feb. 20, 2008

(51) Int. Cl. G06F 13/14

(52) U.S. Cl. 710/305

(57) ABSTRACT

Systems and methods for transferring Ethernet packets from an operating system to a baseboard management controller (“BMC”) have been provided. The operating system is typically stored in a memory. A method according to the invention may include tagging predetermined Ethernet packets for transfer from the operating system to the BMC. The method may also include transferring the tagged Ethernet packets from the operating system to a Local Area Network On Motherboard (LOM). The method may include transferring the tagged Ethernet packets from the LOM to the BMC.

### FIELD OF TECHNOLOGY

The present invention relates generally to internal computer communications and apparatus.

### BACKGROUND OF THE INVENTION

In conventional computer hardware architecture, the baseboard management controller (“BMC”) is accessible from remote computers in the network via an Ethernet controller—i.e., a Local Area Network On Motherboard (“LOM”)—using the management path through protocols such as Intelligent Platform Management Interface¹-Path Through (“IPMI-PT”) or UMP (Universal Management Port). Alternatively, the management path may be accessible through the NC_SI which represents the standard that replaces the UMP. The BMC is a specialized microcontroller embedded on the motherboard of many computers, especially servers. The BMC is the intelligence in the IPMI architecture and typically manages the interface between system ¹The Intelligent Platform Management Interface (IPMI) specification defines a set of common interfaces to computer hardware and firmware which system administrators can use to monitor system health and manage the system. The IPMI consists of the main controller, identified herein as the Baseboard Management Controller (BMC), and other satellite controllers. management software and the platform hardware. However, no high-bandwidth Ethernet connection currently exists between the operating system and the BMC.

For purposes of this application, the term “motherboard” includes a printed circuit board for use as part of the internal hardware in personal computers. The term motherboard is further defined for the purposes of this application as including memory for storing an operating system.

The term “operating system” for the purposes of this application is defined as the software that manages the sharing of the resources of a computer and provides programmers with an interface used to access those resources. The operating system is at the foundation of all system software. The operating system performs basic tasks such as controlling and allocating memory, prioritizing system requests, controlling input and output devices, facilitating networking and managing files systems.

It would be desirable to identify the information packets which should be routed from the operating system to the BMC. In conventional systems, these packets pass to a network via the egress path of the network controller such as the Broadcom BCM 57710 10GbE single-chip C-NIC Ethernet controller or the BCM 5709 NetExtreme Gigabit Ethernet Adapter, each of which is manufactured by Broadcom Corporation of Irvine, Calif. It would be desirable to route such packets directly to the BMC.

It would also be desirable that packets destined for the operating system that are coming from the BMC be routed to the host operating system without being sent on to the network.

### SUMMARY OF THE INVENTION

A system and/or method for using a virtual network interface connection (NIC) with the baseboard management controller (BMC), substantially as shown in and/or described in connection with at least one of the figures, as set forth more completely in the claims.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 is a schematic block diagram of a computer system according to the invention;

FIG. 2 shows a more detailed schematic block diagram of a conventional computer;

FIG. 3 shows a more detailed schematic block diagram of a computer according to the invention; and

FIG. 4 is a schematic diagram of an illustrative single or multi-chip module of this invention in a data processing system.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

As will be appreciated by one of skill in the art upon reading the following disclosure, various aspects described herein may be embodied as a method, a data processing system, or a computer program product. Accordingly, those aspects may take the form of an entirely hardware embodiment, an entirely software embodiment or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof.

In addition, various signals representing data or events as described herein may be transferred between a source and a destination in the form of electromagnetic waves traveling through signal-conducting media such as metal wires, optical fibers, and/or wireless transmission media (e.g., air and/or space).

One embodiment of the invention preferably includes a separate network interface located on the motherboard that implements direct substantially unrestricted, high-bandwidth, communication of Ethernet packets between the operating system and the BMC. One method of implementation according to the invention may include routing to the BMC according to the Media Access Control (“MAC”) addresses/Internet Protocol (“IP”) of the BMC.

The separate interface between the motherboard and the BMC may be helpful in solving certain issues that currently exist in conventional computers. For example, in conventional computers, “jumbo” frames—i.e., Ethernet frames with Maximum Transmission Units (MTU) of more than 1500 bytes of payload (MTU)—can be used on the original network interface but it is not common to have jumbo frames supported in the BMC. A separate interface, according to the invention, for communication between the operating system and the BMC allows the transmission of jumbo frames from the operating system to the BMC.

Another problem that exists in certain conventional computers is that the BMC operates at a relatively substantially slower speed as compared to the operational speed of the network (the UMP interface operates at about 100 MHz and the IPMI is less than 400 KHz compared to 1 GHz or 10 GHz on the network side). Therefore, using the same queues for “regular” network traffic and BMC specific-traffic can cause either hiccups—i.e., temporary reductions—in the network traffic speed (due to the required slow down towards the BMC) or dropping of packets directed towards the BMC.

Another advantage of a separate interface according to the invention is that a separate interface can allow different VLAN tagging (virtual LAN is a group of hosts with a common set of requirements that communicate as if the hosts were attached to the same wire, regardless of their physical location tagging) on the BMC path and on the network path. A separate interface may also provide a communication link between the operating system and the BMC even in the absence of the network link—e.g., when the network link is down.

The following is one embodiment of an implementation skeleton according to the invention. The information host may have separate rings when transmitting information using the interface according to the invention—i.e., the additional interface between the OS and the BMC. An MCP (Management CPU (“Central Processing Unit”)) or other suitable component may be used as the identifier of these rings. This processing unit can transfer the packets from the OS towards the BMC as the MCP does when the MCP receives packets from the network. Conversely, when the MCP receives a packet from the BMC, the MCP can match the destination MAC address or IP against the host MAC address and if the address matches, then the MCP can send the packet to the host instead of the network.

In case of broadcast packets from the BMC, the MCP may duplicate the packet towards both the network and the host. Furthermore, in an embodiment of the invention that involves multicast—i.e., broadcasting the same copy of multimedia packets over the entire network to all clients—the packets can also be sent to both the network and the host.

In certain embodiments of the invention, matching hardware may be implemented as follows. Matching hardware may preferably sort packets from the BMC to determine which packets should be transferred to the host and which should be transferred to the network. It should be noted that, in a preferred embodiment of the invention, the interface according to the invention eliminates the need to sort the packets from the host to the BMC. The packets from the operating system destined for the BMC do not need to be sorted because they have been pre-tagged for transfer to the BMC using the BMC MAC address or IP.

To reiterate one statement of the problem and a solution according to the invention, in conventional computer hardware there is no way to send Ethernet packets from the host operating system to the BMC without going through the network. The invention may solve this problem by including a separate network interface between the operating system and the BMC. Thus, the invention, in one embodiment, may be defined as another “network connection” that allows traffic bi-directionally between the operating system and the BMC.

This “network connection”, however, preferably does not allow the information to proceed to the network. Rather, any communications from the BMC to the network or from the network to the BMC will proceed along a separate network connection.

Some advantages of having a separate network adaptor or connection from the management CPU or other suitable hardware that connects the host operating system to the BMC may include providing a platform to continue to allow the operating system to communicate with the BMC even if the network link is down. Furthermore, the routing to the BMC may be done in the operating system according to the MAC addresses/IP of the BMC so there is almost no filtering required by the chip in that direction. This can preferably reduce hardware complication and possibly allow all the filtering and sorting of packets to be done in firmware without any reduction in performance.

Another aspect of the invention relates to the synchronization of using the same ingress queue for packets from the network and from the BMC. Synchronization of using the same ingress queue for packets from the network and from the BMC is complicated. The complexity derives from the aggregating of two different information paths in the chip. The invention, however, provides two different, separate, ingress queues for packets from the network and from the BMC. Accordingly, two different ingress queues according to the invention preferably simplify work that needs to be done by the computer to process traffic.

Yet another aspect of the invention relates to “teaming”. Teaming provides load-balancing, fault-tolerance, and VLAN features. These features are provided by creating teams that include multiple NIC interfaces. Each interface within the team can be designated primary, or hot-standby. All primary NIC interfaces in a team preferably participate in load-balancing operations by sending and receiving a portion of the total traffic. Hot-standby interfaces will take over in the event that all primary interfaces have lost their links. VLANs can be added to a team to allow multiple VLANs with different VLAN IDs. A virtual device is created for each VLAN added. The additional interface between BMC and the host operating system allows the other host operating system network port to be part of teaming and the communication with the BMC will not interrupt in the same fashion as the communications with the BMC interrupt when used on the same port.

Another aspect of the invention may involve using a different IP subnet mask—i.e., a mask used to determine what subnet an IP address belongs to—for the BMC than the IP subnet mask used by the operating system.

Having the ability to more fully interact with the BMC over Ethernet from the local host operating system may include using the already existing infrastructure which exists to support managing the computer from a remote machine. That means that the user of an interface according to the invention is able to access HTTP menus that are conventionally available only from a remote machine. In such an embodiment, the user may also possess the ability to control the HTTP menus from the local host in the same way the user would if he was using a remote machine

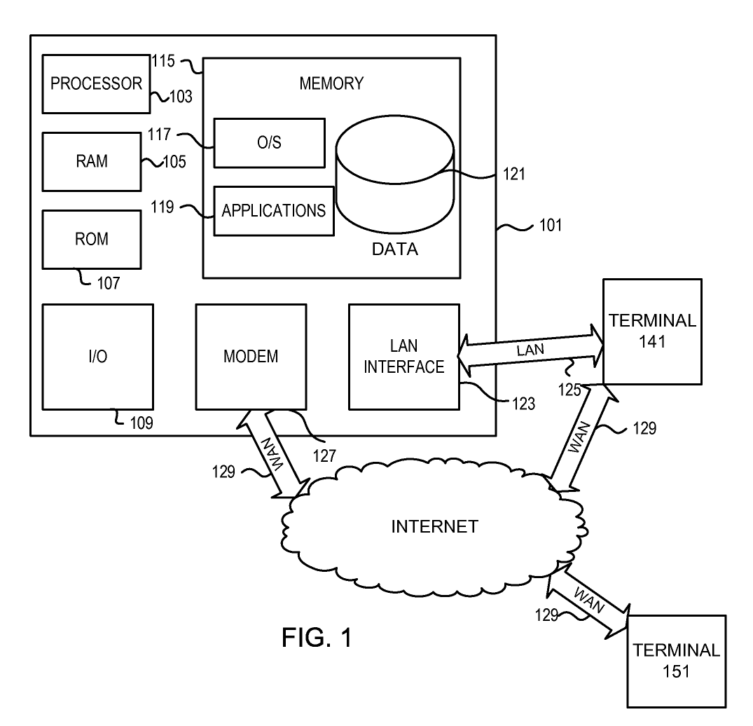

FIG. 1 illustrates a block diagram of a generic computing device 101 (alternatively referred to herein as a “server”) that may be used according to an illustrative embodiment of the invention. Computer server 101 may have processor 103 for controlling overall operation of the server and its associated components, including RAM 105, ROM 107, input/output module 109, and memory 115.

I/O module 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 115 and/or storage to provide instructions to processor 103 for enabling server 101 to perform various functions. For example, memory 115 may store software used by server 101, such as an operating system 117, application programs 119, and an associated database 121. Alternatively, some or all of server 101 computer executable instructions may be embodied in hardware or firmware (not shown).

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include local area network (LAN) 125 and wide area network (WAN) 129, but may also include other networks. When used in a LAN networking environment, computer 101 is connected to LAN 125 through a network interface or adapter 123. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119 used by server 101 according to an illustrative embodiment of the invention may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

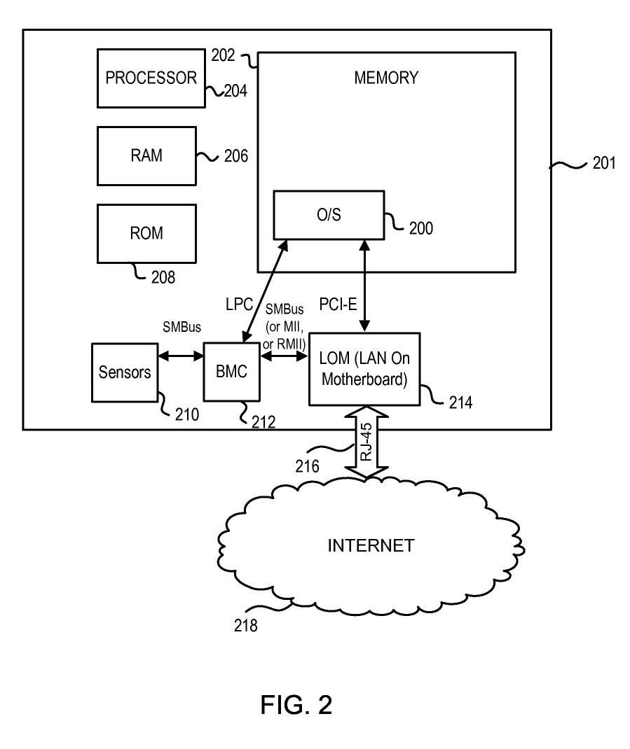

FIG. 2 shows a more detailed schematic block diagram of a conventional computer 201 that includes hardware that may be enhanced by an addition of a direct interface (not shown explicitly in FIG. 2) between the operating system—i.e., the memory that stores the operating system—and the BMC. Memory 202 preferably stores operating system 200. Processor 204, RAM 206, and ROM 208 are shown for illustrative purposes. Their respective functions are defined more fully above with respect to FIG. 1.

FIG. 2 also shows a PCI (Peripheral Component Interconnect) Express interface connection between operating system 200 and LOM (LAN on Motherboard) 214. PCI Express, officially abbreviated as PCI-E or PCIe, is a computer expansion card interface format. Alternatively, one of the older PCI or PCI-X interfaces could also be implemented between operating system 200 and LOM 214.

LOM 214 may act as the Ethernet controller for computer 201. RJ-45 jack 2182 may be the type of connector by which LOM 214 communicates with the Internet 220. ²Registered Jack-45, an eight-wire connector used commonly to connect computers onto a local-area networks (LAN), especially Ethernets.

BMC 212 may communicate with temperature, fan, or voltage sensors 210 via an SMBus (System Management Bus—a simple two-wire bus, derived from I2C). BMC 212 also allows for remote controlling of computer 201 via LOM 214.

Typically, LOM 214 communicates with BMC 212 via a System Management Bus (“SMBus”),³ via an MII interface⁴ or via an RMII interface⁵ LOM 214 acts as a conduit for BMC messages sent to operating system 200. ³An SMBus is typically used for communication with low-bandwidth devices on a motherboard, such as power-related chips, as well as temperature, fan, or voltage sensors; and lid switches.⁴An MI (Media Independent Interface) is a standard interface used to connect a Fast Ethernet MAC-block to a PHY. The MII may connect two chips on the same printed circuit board.⁵An RMII (Reduced Media Independent Interface) is a standard that addresses the connection of Etherenet physical layer transceivers (PHY) to Ethernet switches. It reduces the number of signals/pins required for connecting to the PHY

In such an embodiment of a computer 201, BMC 212 typically advertises itself to an interface) to 6 to 10. RMII is capable operating system agent—i.e., a preferably autonomous module that acts as an intermediary transmissions need a wider interface between the operating system and LOM 214. The operating system agent gets sensor information from BMC 212 via LOM 214.

In such an embodiment of a computer 201, BMC 212 typically advertises itself to an operating system agent—i.e., a preferably autonomous module that acts as an intermediary between the operating system and LOM 214. The operating system agent gets sensor information from BMC 212 via LOM 214.

There typically also is a conventional low pin count (“LPC”) bus between BMC 214 and operating system 200. However, the LPC does not allow for transfer of Ethernet packets nor does it support Internet protocol-based communications. Accordingly, there is a need for an interface between the BMC and the operating system that allows for the transfer of Ethernet packets.

The following is a short introduction to communications via Internet protocol in order to better understand the invention. Ethernet packets may be transferred using Transmission Control Protocol (TCP). TCP is one of the core protocols of the Internet protocol suite. TCP provides reliable, in-order delivery of a stream of bytes, making it suitable for applications like file transfer and e-mail. It is so important in the Internet protocol suite that sometimes the entire suite is referred to as “the TCP/IP protocol suite.” The transfer of The Internet Protocol (IP) works by exchanging groups of information packets. Packets typically include short sequences of bytes consisting of a header and a body. The header describes the packet's destination, which routers on the Internet use to pass the packet along, in generally the right direction, until it arrives at its final destination. The body of the packet contains the application data.

The TCP software libraries use the IP and provides a simpler interface to applications by hiding most of the underlying packet structures, rearranging out-of-order packets, minimizing network congestion, and re-transmitting discarded packets. Thus, TCP very significantly simplifies the task of writing network applications.

TCP is used extensively by many of the Internet's most popular application protocols and resulting applications, including the World Wide Web, E-mail, File Transfer Protocol, Secure Shell, and some streaming media applications.

However, because TCP is optimized for accurate delivery rather than timely delivery, TCP sometimes incurs long delays while waiting for out-of-order messages or retransmissions of lost messages, and it is not particularly suitable for real-time applications such as Voice over IP. For such applications, protocols like the Real-time Transport Protocol (RTP) running over the User Datagram Protocol (UDP) are usually recommended.

Accordingly, it would be desirable to send packets using TCP or UDP back and forth between the operating system and the BMC.

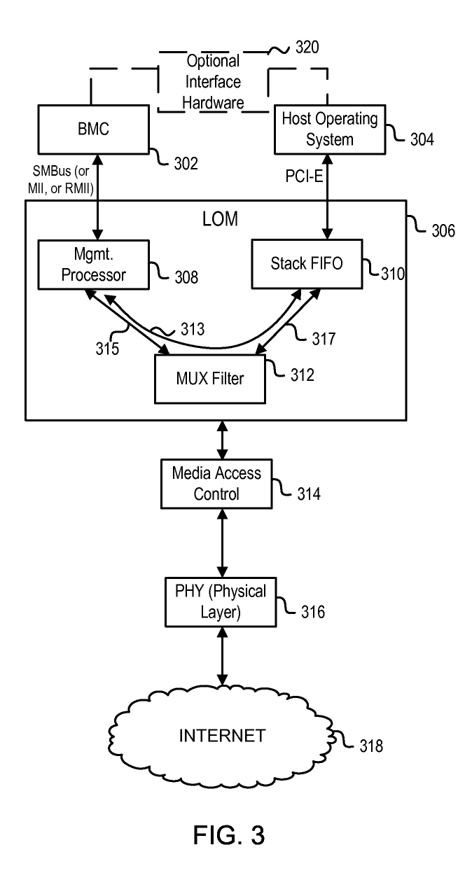

FIG. 3 shows one possible implementation of an interface inside a LOM 306 gigabit controller such as the Broadcom® BCM5751 which is a NetXtreme™ Gigabit Ethernet (GbE) controller produced by Broadcom Corporation of Irvine, Calif., a Broadcom® BCM57710, Broadcom® BCM57711 or any other suitable Gigabit Ethernet controller. FIG. 3 also shows BMC 302, host operating system 304, management processor 308, stack FIFO 310 (First-In, First-Out buffer where data is stored and where the data can either be removed along the path that it was originally stored or along a second path), multiplexing filter 312 (“MUX”), Media Access Control 314, and PHY (Physical Layer) 316. PHY 316 may preferably be connected to the Internet 318.

One feature of the invention is that the interface between BMC 302 and operating system 304 may preferably be implemented in LOM 306, which already exists in conventional computers. This interface may preferably be implemented by changing the driver in the operating system 304 such that any Ethernet packets transmitted from operating system 304 that are bound for BMC 302 may preferably be routed directly to BMC instead of out to the Internet. Additionally, this interface may also be implemented such that Ethernet packets from BMC may be filtered by MUX filter 312 and, if selected by MUX filter 312 as destined for operating system 304, then such selected packets can be transferred to stack FIFO 310.

Accordingly, two new data paths exist in LOM 306 according to the invention. A first data path is 313 which transfers data originating in operating system 304 towards BMC 302. The data along first data path 313 is preferably tagged by the operating system 304 with the MAC address and/or IP protocol of BMC 302. This tagging may preferably be implemented by implementing changes to the LOM driver, or other appropriate driver, in the operating system code. Thus, one embodiment of the invention may include a virtual interface as implemented by revisions to the LOM driver. Typically, the LOM driver is resident in the operating system.

It should be noted that the connection between LOM 306 and BMC 302 may be implemented using an SMBus connector, an MII interface, or an RMII interface. Operating system 302 may be connected to LOM 306 using PCI-E or any other suitable interface.

A second data path is 315/317 which preferably transfers data originating in BMC 302 towards operating system 304. The second data path 315/317 preferably filters data that is destined for operating system 304 and transfers it to stack FIFO 310 on the way to operating system 304.

Data that is destined for the Internet is preferably transferred from LOM 306 to Media Access Control 314, PHY (Physical Layer) 316, and then on to (or from) the Internet 318.

In alternate embodiments of the invention, optional hardware 320 may be used to provide a completely separate hardware interface between operating system 304 and BMC 302.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

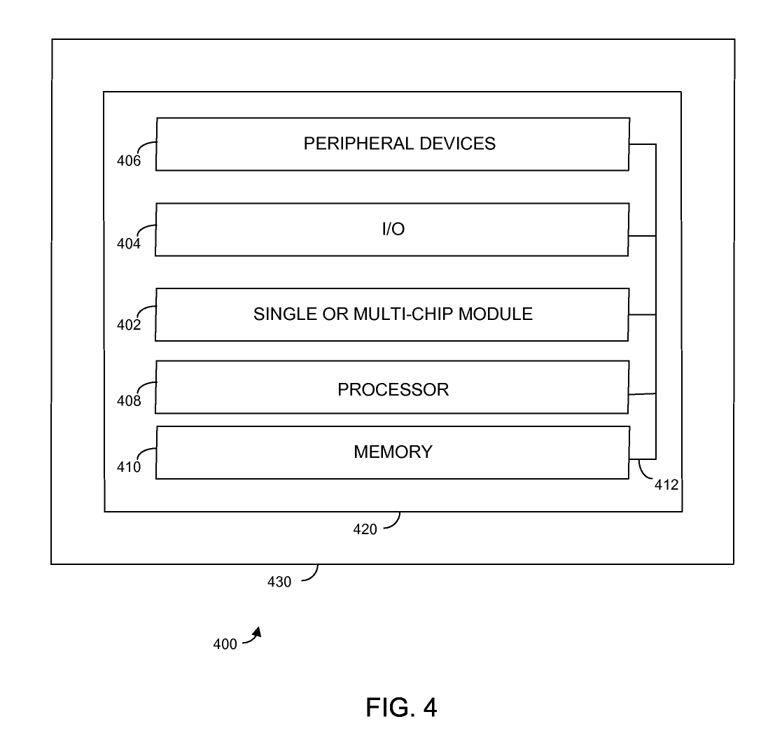

FIG. 4 shows a single or multi-chip module 402 according to the invention, which can be one or more integrated circuits, in an illustrative data processing system 400 according to the invention. Data processing system 400 may include one or more of the following components: I/O circuitry 404, peripheral devices 406, a processor 408 and memory 410. These components are coupled together by a system bus or other interconnections 412 and are populated on a circuit board 420 which is contained in an end-user system 430. System 400 may be configured for use in a computer according to the invention. It should be noted that system 400 is only exemplary, and that the true scope and spirit of the invention should be indicated by the following claims.

Thus, systems and methods for providing systems and methods for providing a virtual network interface connection (NIC) with the baseboard management controller (BMC) have been described.

Aspects of the invention have been described in terms of illustrative embodiments thereof. A person having ordinary skill in the art will appreciate that numerous additional embodiments, modifications, and variations may exist that remain within the scope and spirit of the appended claims. For example, one of ordinary skill in the art will appreciate that the steps described in methods set forth herein may be performed in other than the recited order and that one or more steps may be optional. The methods and systems of the above-referenced embodiments may also include other additional elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

What is claimed is:

1. A method of transferring Ethernet packets from an operating system to a baseboard management controller (“BMC”), the operating system being stored in a memory, the method comprising:
tagging predetermined Ethernet packets for transfer from the operating system to the BMC;
transferring the tagged Ethernet packets from the operating system to a Local Area Network On Motherboard (“LOM”); and
transferring the tagged Ethernet packets from the LOM to the BMC.

2. The method of claim 1 further comprising tagging the predetermined packets using a LOM driver.

3. The method of claim 1 further comprising transferring the tagged Ethernet packets from the operating system to the LOM using a PCI (Peripheral Component Interconnect)-Express interface.

4. The method of claim 1 further comprising transferring the tagged Ethernet packets from the LOM to the BMC using one of an SMBus (System Management Bus) interface, an MII interface, and an RMII interface.

5. A method of transferring Ethernet packets from a baseboard management controller (“BMC”) to an operating system, the operating system being stored in a memory, the method comprising:
transferring the Ethernet packets from the BMC to a Local Area Network On Motherboard (“LOM”); and
selecting a portion of the Ethernet packets for transfer from the LOM to the operating system; and
transferring the selected Ethernet packets from the LOM to the operating system.

6. The method of claim 5 further comprising selecting the Ethernet packets using a multiplexing filter.

7. The method of claim 5 further comprising transferring the selected Ethernet packets to the operating system using a PCI(Peripheral Component Interconnect)-Express interface.

8. The method of claim 5 further comprising transferring Ethernet packets from the LOM to the BMC using one of an SMBus (System Management Bus) interface, an MII interface, and an RMII interface.

9. A computer comprising:
a memory, the memory storing an operating system;
a baseboard management controller (“BMC”); and
a Local Area Network On Motherboard (“LOM”);
wherein the operating system comprises a module for tagging predetermined Ethernet packets, the predetermined Ethernet packets for transfer via the LOM from the operating system to the BMC.

10. The computer of claim 9 wherein the module comprises a LOM driver.

11. The computer of claim 9 further comprising a PCI(Peripheral Component Interconnect)-Express interface that acts as a conduit to transfer the identified Ethernet packets from the operating system to the LOM.

12. The computer of claim 9 further comprising one of an SMBus (System Management Bus) interface, an MI interface, and an RMII interface, said one interface that acts as a conduit to transfer the identified Ethernet packets from the LOM to the BMC.

13. A computer comprising:
a memory, the memory storing an operating system;
a baseboard management controller (“BMC”); and
a Local Area Network On Motherboard (“LOM”), the LOM comprising a multiplexing (“MUX”) filter, the LOM for receiving Ethernet packets from the BMC and for selecting a portion of the received Ethernet packets for transfer from the LOM to the operating system.

14. The computer of claim 13, the LOM further comprising a MUX filter for selecting the Ethernet packets for transfer from the LOM to the operating system.

15. The computer of claim 13 further comprising a PCI(Peripheral Component Interconnect)-Express interface for transferring the selected Ethernet packets from the LOM to the operating system.

16. The computer of claim 13 further comprising one of an SMBus (System Management Bus) interface, an MII interface, and an RMII interface, said interface for transferring Ethernet packets from the LOM to the BMC.
